(19) United States
(12) Patent Application Publication
(10) Pub. No.: US 2013/0057146 A1
(43) Pub. Date: Mar. 7, 2013

(54) CONCENTRATED LIGHT EMITTING DEVICE

(71) Applicant: Tsu-Min CHAO, Guanyin Township (TW)

(72) Inventor: Tsu-Min CHAO, Guanyin Township (TW)

(21) Appl. No.: 13/227,336

(22) Filed: Sep. 7, 2011

(51) Int. Cl. H05B 41/36

(52) U.S. Cl. 315/56

(57) ABSTRACT

A concentrated light emitting device includes a transparent casing, a printed circuit board in the transparent casing, a drive module and a light emitting element, which is a single element, plural elements arranged alternately or a module, on the printed circuit board. The drive module and the light emitting element are on one or two sides of the printed circuit board, the drive module includes a regulator circuit without electrolytic capacitors and the light emitting element is an LED or an organic LED. The light emitting device is used in a fluorescent lamp of a smaller diameter, like a T5 fluorescent lamp (i.e., a fluorescent lamp of a diameter of ⅝″ or 16 mm). The present invention is capable of matching with an external drive module and providing a dedicated bracket for the external drive module, which can reduce production cost and can be installed more conveniently.

### BACKGROUND OF THE INVENTION

a) Field of the Invention

The present invention relates to a concentrated light emitting device, and more particularly to a concentrated light emitting device which is simple in structure and is concentrated that a production cost can be reduced as well as there is no need to consider matching with an external drive module and providing a dedicated bracket for the external drive module, so that the concentrated light emitting device can be installed more conveniently.

b) Description of the Prior Art

As larger electrolytic capacitors are used for a drive module of a conventional fluorescent lamp, a too large a space will be taken and a dedicated bracket is needed for installation. Besides, the size of an entire luminaire cannot be decreased and the installation is not very convenient. As a result, in recent years, as the development of production technology, the light emitting diode (LED) has been gradually and widely used in illumination and lamp decoration. However, as the light emitting diode is powered by a DC (Direct Current) voltage, an LED luminaire should be provided with a matching drive module. In an existing technology, the drive module is separate from the LED, such as a T5 fluorescent lamp (i.e., a fluorescent lamp of a diameter of ⅝″ or 16 mm), a drive module of which is installed in a bracket. Hence, following drawbacks exist:
1. As the drive module is separate from a transparent casing of the light emitting device, it is necessary to consider interconnection between the two parts and transmission of electricity during installation. In particular, an installation location of the drive module needs to be taken into consideration, which results in a trouble in the installation.
2. As the external bracket is required during the installation and there are quite a lot of types of the drive module and the luminaire, yet they cannot be used interchangeably, it is often necessary to re-consider the matching between the two parts when changing a light tube or the drive module, so that the existing LED luminaire is not very convenient in installation and use.

Accordingly, the present invention is to enable the LED luminaire to be installed and used more conveniently.

### SUMMARY OF THE INVENTION

The primary object of the present invention is to provide a concentrated light emitting device that the structure of the LED luminaire is simpler and concentrated to reduce the production cost, without the need to consider the matching with the external drive module and the provision of the dedicated bracket for the external drive module, so that the installation can be more convenient.

The abovementioned concentrated light emitting device includes a transparent casing, a printed circuit board in the transparent casing, a drive module and a light emitting element on the printed circuit board, with that the light emitting element is configured as a single element, plural elements arranged alternately or a module. The drive module and the light emitting element are provided on one side or two sides of the printed circuit board and the drive module includes a regulator circuit without electrolytic capacitors, constituting a light emitting device for use in a fluorescent lamp of a smaller diameter, such as a T5 fluorescent lamp (i.e., a fluorescent lamp of a diameter of ⅝″ or 16 mm). The present invention is simple in structure and is concentrated that the production cost can be reduced without the need to consider the matching with the external drive module and the provision of the dedicated bracket for the external drive module, so that the light emitting device can be installed more conveniently.

For the abovementioned concentrated light emitting device, the drive module includes a rectification circuit, an integrated constant-current module and an integrated regulation module, wherein the integrated regulation module is a regulator circuit without electrolytic capacitors. Therefore, the drive module and the light emitting device can be provided together in the transparent casing to reduce the size of the luminaire.

For the abovementioned concentrated light emitting device, the printed circuit board is a single-sided or double-sided printed circuit board to facilitate installing the drive module and the light emitting element.

For the abovementioned concentrated light emitting device, the light emitting element is an LED or an organic LED.

For the abovementioned concentrated light emitting device, the light emitting element is an insertion-type LED or a patch-type (SMD, Surface Mount Device) LED.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a printed circuit board of the present invention.

FIG. 2 shows another three-dimensional view of the printed circuit board of the present invention.

FIG. 3 shows a three-dimensional exploded view of the present invention.

FIG. 4 shows a block diagram of a drive module of the present invention.

FIG. 5 shows a cutaway view of the present invention after being assembled.

### DETAILED DESCRIPTION OF THE PREFERRED EMBODIMENTS

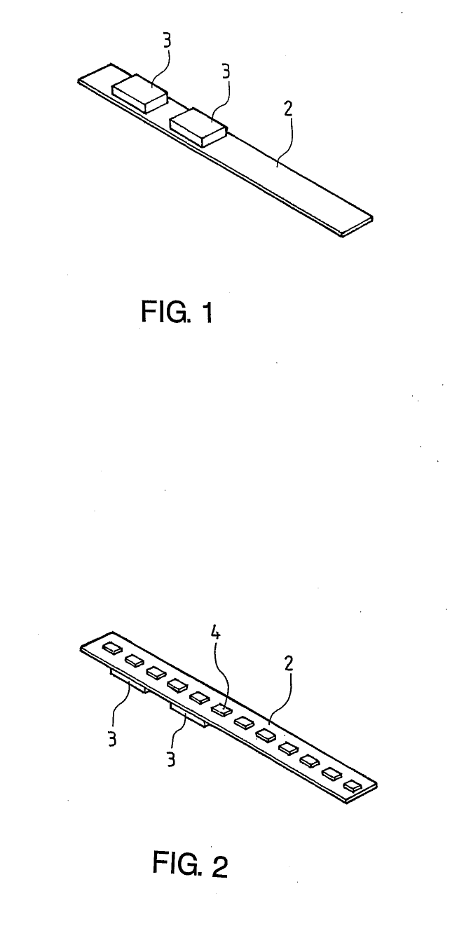

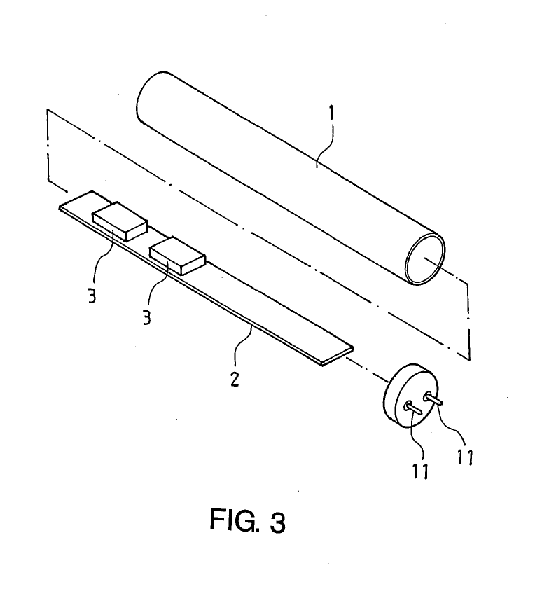

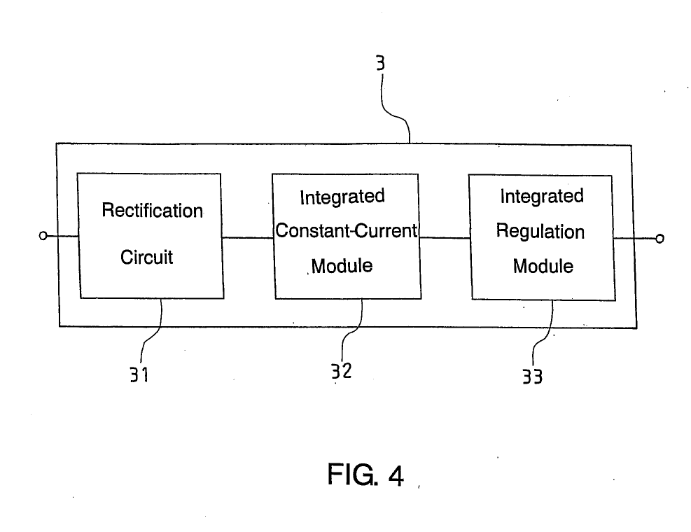

Referring to FIG. 1 and FIG. 2 at a same time, in association with FIG. 3 and FIG. 4, showing three-dimensional views and a three-dimensional exploded view of a printed circuit board, as well as a block diagram of a drive module, the present invention comprises a transparent casing 1, a printed circuit board 2 which is provided in the transparent casing 1, as well as a drive module 3 and a light emitting element 4 which are provided on the printed circuit board 2. In the present embodiment, the printed circuit board 2 is a double-sided printed circuit board, enabling the drive module 3 and the light emitting element 4 to be provided on two sides of the printed circuit board 2. Of course, the printed circuit board 2 can be also a single-sided printed circuit board that the drive module 3 and the light emitting element 4 are provided on a same side of the printed circuit board 2. The drive module 3 includes a rectification circuit 31, an integrated constant-current module 32 and an integrated regulation module 33, wherein the integrated regulation module 33 is a regulator circuit without electrolytic capacitors.

The light emitting element 4 is provided as a single element, plural elements arranged alternately or a module. The light emitting element 4 is an LED or an organic LED and is an insertion-type LED or a patch-type (SMD) LED.

By the assembly of the abovementioned components, the printed circuit board 2 that includes the drive module 3 and the light emitting element 4 is provided in the transparent casing 1. An end of the transparent casing 1 is sheathed with pins 11 to constitute a light emitting device for use in a fluorescent lamp of a smaller diameter, such as a T5 fluorescent lamp (i.e., a fluorescent lamp of a diameter of ⅝″ or 16 mm), so that when the light emitting device is used, the pins 11 are connected to an AC (Alternating Current) lamp socket and the light emitting element 4 is triggered by the alternating current through the drive module 3. The present invention is simple in structure and is concentrated so that the production cost can be reduced without a need to consider the matching with an external drive module and the provision of a dedicated bracket for the external drive module, thereby enabling the installation to be more convenient.

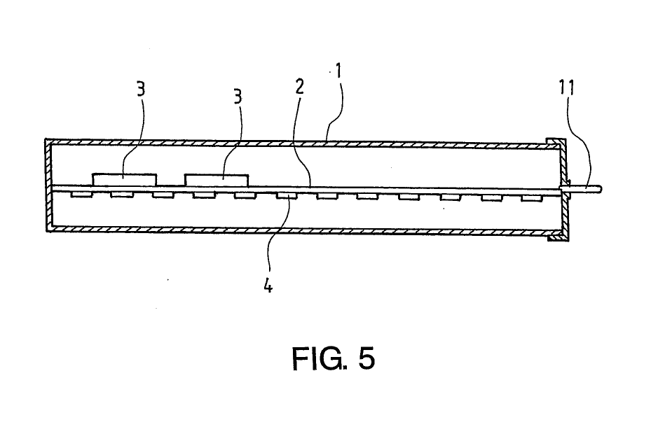

Referring to FIG. 5, it shows a cutaway view of the present invention after being assembled. As shown in the drawing, after being assembled, the printed circuit board 2, which includes the drive module 3 and the light emitting element 4, is provided in the transparent casing 1. An end or two ends of the transparent casing 1 is sheathed with the pins 11 for use with the fluorescent lamp of a smaller diameter, such as the T5 fluorescent lamp (i.e., a fluorescent lamp of a diameter of ⅝″ or 16 mm), so that when the light emitting device is used, the pins 11 are connected to an AC lamp socket and the light emitting element 4 is triggered by the alternating current through the drive module 3. The present invention is simple in structure and is concentrated so that the production cost can be reduced without a need to consider the matching with an external drive module and the provision of a dedicated bracket for the external drive module; therefore, the light emitting device can be installed and used more conveniently.

The present invention is at least provided with following advantages comparing to the existing LED luminaire:
1. The drive module 3 and the light emitting element 4 are all concentrated in the same transparent casing 1, which reduces the size of the luminaire without affecting the lighting efficiency.
2. The light emitting device is directly inserted into the AC lamp socket when installing, without the need to use the external bracket for loading as the conventional LED luminaire. Therefore, the installation is convenient and the cost of installation can be saved.
3. When the luminaire is malfunctioning, it is only need to replace the entire light emitting device without considering the matching problem of the external drive module with the luminaire as the conventional LED luminaire, which is rather convenient and time saving.
4. As the size is largely reduced, the present invention can be applied to not only the T5 fluorescent lamp (i.e., a fluorescent lamp of a diameter of ⅝″ or 16 mm), but a T8 (i.e., a fluorescent lamp of a diameter of 8/8″ or 25.4 mm), T10 (i.e., a fluorescent lamp of a diameter of 10/8″ or 31.8 mm) or T12 (i.e., a fluorescent lamp of a diameter of 12/8″ or 38.1 mm) fluorescent lamp. Therefore, the area of application is very broad.
5. The production cost and the failure rate of the drive module 3 can be reduced, which can decrease relatively the production cost of the entire light emitting device and improve the quality of the light emitting device.

Accordingly, in the present invention, the concentrated light emitting device is constituted by the printed circuit board, which is provided with the drive module and the light emitting element, and the transparent casing which is provided with the pins. The present invention enables the structure of the LED luminaire to be simpler and concentrated, so that the production cost can be reduced and there is no need to consider the matching with the external drive module and the provision of the dedicated bracket for the external drive module, enabling the installation to be more convenient.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A concentrated light emitting device comprising a transparent casing, a printed circuit board in the transparent casing as well as a drive module and a light emitting element on the printed circuit board, wherein the drive module and the light emitting element are provided on one side or two sides of the printed circuit board to constitute a light emitting device through interconnection with the printed circuit board; the light emitting device being applied to a fluorescent lamp of a smaller diameter, without the need to consider the matching with an external drive module and the provision of a dedicated bracket for the external drive module.

2. The concentrated light emitting device according to claim 1, wherein the drive module includes a rectification circuit, an integrated constant-current module and an integrated regulation module, with that the integrated regulation module is a regulator circuit without electrolytic capacitors, enabling the drive module and the light emitting element to be provided together in a transparent casing to reduce the size of a luminaire.

3. The concentrated light emitting device according to claim 1, wherein the printed circuit board is a single-sided or double-sided printer circuit board to facilitate installing the drive module and the light emitting element.

4. The concentrated light emitting device according to claim 1, wherein the light emitting element is an LED (light emitting device) or an organic LED.

5. The concentrated light emitting device according to claim 4, wherein the light emitting element is an insertion-type LED or a patch-type LED.

6. The concentrated light-emitting device according to claim 4, wherein the light emitting element is provided as a single element, plural elements arranged alternately or a module.

7. The concentrated light emitting device according to claim 1, wherein an end or two ends of the transparent casing is sheathed with pins to connect to an AC (Alternating Current) lamp socket, thereby triggering the light emitting element by the alternating current through the drive module.
